(19) United States
(12) Patent Application Publication
(10) Pub. No.: US 2026/0288755 A1
(43) Pub. Date: Sep. 24, 2026

(54) STATISTICAL ACCESS PREDICTION WITH DATABASES

(71) Applicant: International Business Machines Corporation, Armonk, NY (US)

(72) Inventors: Rene Blath, Weil im Schoenbuch (DE); Reinhold Geiselhart, Rottenburg-Ergenzingen (DE); Juergen Schimpf, Schoenaich (DE)

(21) Appl. No.: 19/330,986

(22) Filed: Sep. 17, 2025

(30) Foreign Application Priority Data
Mar. 18, 2025 (GB) 2503922.3

(51) Int. Cl. G06F 16/27; G06F 16/23

(52) U.S. Cl. CPC G06F 16/27; G06F 16/235

(57) ABSTRACT

A method, system, and computer program product can determine an access frequency for a data element in a target database based on a number of access events for the data element in a reference time window of a defined time-length. The data element can be updated from a data source according to a refresh pattern determined based on the access frequency, wherein the updating comprises updating the data element with an update frequency at least twice the access frequency.

### BACKGROUND

The present disclosure relates to database management systems and, more specifically, updating data in a target database.

In cloud computing systems, highly interconnected computer systems, storage systems and other infrastructure components can be operated in such a way that data and information of all kinds must be exchanged between these interconnected systems. Since data/information is stored in multiple copies at multiple locations, maintaining its consistency can require sending large amounts of data/information over a network, which can represent a significant cost factor. Another challenge in this context can be data latency, which refers to how long it takes for the data to be synchronized again after changes in one place of the network, and how costly it is to keep data latency to a minimum.

### SUMMARY

Various embodiments are directed to a method, which can include determining an access frequency for a data element in a target database based on a number of access events for the data element in a reference time window of a defined time-length. The method can also include updating the data element from a data source according to a refresh pattern determined based on the access frequency, wherein the updating comprises updating the data element with an update frequency at least twice the access frequency.

Further embodiments are directed to a system, which includes a memory and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a flow diagram illustrating a process of updating data in a database system, according to some embodiments.

FIG. 2 is a set of schematic diagrams showing examples of access events in reference time windows, according to some embodiments.

FIG. 3 is a schematic diagram showing another example of access events in reference time windows, according to some embodiments.

FIG. 4 is a schematic diagram showing a further example of access events in reference time windows, according to some embodiments.

FIG. 5 is a schematic diagram illustrating a neural network for updating data in a database system, according to some embodiments.

FIG. 6 is a set of schematic diagrams illustrating examples of architecture approaches for data sources and target databases, according to some embodiments.

FIG. 7 is a schematic diagram illustrating examples of managing metadata for data elements, according to some embodiments.

FIG. 8 is a flow diagram illustrating a process of selecting an update mode for data elements in a target database, according to some embodiments.

FIG. 9 is a flow diagram illustrating a process of monitoring access to data elements for evaluating/updating refresh patterns of the data elements in a target database, according to some embodiments.

FIG. 10 is a block diagram illustrating a database management system for updating data in a target database, according to some embodiments.

FIG. 11 is a block diagram illustrating a computing environment, according to some embodiments.

### DETAILED DESCRIPTION

Aspects of the present disclosure relate generally to database management systems and, more specifically, updating data in a target database. While the present disclosure is not necessarily limited to such applications, various aspects of the disclosure may be appreciated through a discussion of various examples using this context.

Cloud computing systems are steadily on the rise and—in many cases—have become the preferred operating mode for enterprise IT (information technology) infrastructures. With this development, countless instances of highly interconnected computer systems, storage systems and other infrastructure components are operated in such a way that data and information of all kinds must be exchanged between these interconnected systems. A particular requirement, and in addition also a specific problem in this area, is to ensure data consistency across the distributed systems.

This does not necessarily apply to all types of information and data in general, but in a globally interconnected world of information, it is increasingly assumed and expected that data will be consistent, regardless of how and in which computer system it resides. Since data/information is stored in multiple copies at multiple locations, there is a corresponding need to send much more data/information over a network, which also represents a significant cost factor. The problem needs to be addressed with an appropriate “data replication” and “data storage” approach that keeps the required effort and cost of maintaining multiple copies at a reasonable level.

Another challenge in this context is data latency, which refers to how long it takes for the data to be synchronized again after changes in one place of the network, and how costly it is to keep data latency to a minimum. Various techniques have been tried to find a generally acceptable solution to this additional problem. However, all of the techniques used today have their limitations. In general, consumers and data consuming systems, such as enterprise applications, assume that they are accessing the latest version of any given data. Consequently, system designers are faced with the challenge of finding an optimal pattern for updating data at a target storage location, such as a target database, to keep costs as low as possible without compromising data reliability and freshness. Ideally, such an optimal pattern may be applied at a high level of data granularity.

The traditional techniques described above can be limited in their flexibility to efficiently adapt to randomly changing data accesses. However, embodiments disclosed herein may offer a more flexible update process for data and a target database. In some embodiments, this enables updating, refreshing, or replicating data in a target database, e.g., target database system, when necessary (e.g., for the data consumer, user, and/or application), rather than every time data elements have changed. When data is moved and copied within a system without anyone accessing the newly updated information, updating, refreshing, or replicating data in a target database may waste resources and should therefore be avoided. On the other hand, if data is getting stale, e.g., if is not updated in time before it is needed, this may have negative consequences for data consumers.

Various embodiments may enable, e.g., establishing a reasonable prediction of future data needs, updating/refreshing data just before it is consumed, achieving transparency for data consumers, and ensuring a minimum level of data freshness. In some embodiments, by using a machine learning system, “fail-safe” strategies may be implemented in case a reasonable prediction of the next data access is not possible. Additionally, a mixed operation between sampled data and not sampled data in the same data source and/or target database or target database system is possible, e.g., by providing metadata to differentiate between data elements that allow sampling and those that do not.

The aforementioned advantages are example advantages and should not be construed as limiting. Embodiments of the present disclosure can contain all, some, or none of the aforementioned advantages while remaining within the spirit and scope of the present disclosure.

As discussed in greater detail below, the disclosed techniques can include starting a new reference time window at the end of a previous reference time window. This may be described as a back-to-back case. In this scenario, the reference time windows may be of equal length. In another embodiment, a new reference time window may start each time a data element is accessed. In these instances, there may be overlapping reference time windows. Therefore, more frequent determinations may be made to adapt the update (or refresh) rate or frequency to the data element, and, in general, to a plurality of data elements. However, also in this embodiment the reference time window may be assumed to have a fixed length.

The disclosed techniques may also include dynamically adjusting a defined time-length for a next or subsequent reference time window(s) depending on the number of times a data element is accessed in a current reference time window compared with a number of access events in previous time windows. That is, if the number of access events for the data element in a current reference time window is increased relative to previous window(s), the (pre-)defined time-length can be reduced. This may be implemented by using a predefined formula, e.g., F_{update} = f (number of access events measured in a current reference time window compared with the average number of accesses in previous reference time windows). In general, a reciprocal function may be used. In various embodiments, a maximum length of the reference time window should not be exceeded.

In further embodiments, adjusting the defined time-length of the reference time window can use a trained machine learning system that includes a trained machine learning model. In these embodiments, time delta (td) values, which measure a distance between the access events for a data element in the target database, and a current update frequency value may be used as input for the machine learning system. Examples of the machine learning system used may include different types of RNNs (recurrent neural networks), CNNs (convolutional neural networks), and the like. Examples of predictions output by the machine learning system may include a sampling recommendation (e.g., a yes/no or on/off recommendation) for using the sampling method for the data element, an update frequency for the data element, further sampling properties of the data element (e.g., a quality value of an update frequency prediction or a randomness value to the particular data element), and based on the properties, a risk factor for updating.

In some embodiments, refresh patterns for a data element can be adjusted. For example, if an absolute value of a difference between a predicted update frequency for a data element and a measured access frequency for the same data element is larger than a first predefined difference value, the update frequency value of the data element can be decreased. Alternatively, if the absolute value of the difference between the predicted update frequency and the measured access frequency for the same data element is larger than a second predefined difference value, the update frequency value for the data element can be increased. This way, a hysteresis effect may be implemented in order to avoid too many changes to the update frequency value for the data element. This may save valuable computing resources.

In additional embodiments, a data element in a target database can be updated if a required data quality value, e.g., a data freshness indicator value, is below a predefined data quality value. The determined data quality value may be part of the prediction output of the machine learning system used (see above) or may be defined by or during access to the data element by an application. Such additional updating of the data element may be considered as an exception to updating the data element with the defined update frequency. Therefore, additional update cycles for the data element can be implemented in these embodiments.

In some embodiments, the data quality value may be expressed as a ratio between a previously predicted refresh pattern and an actually measured access frequency to the same data element. For example, in various embodiments, the update frequency for the data element should be relatively close to twice the access frequency. This may avoid undesirable scenarios in which the predicted update frequency is either too high or too low when compared to the access frequency. In the former scenario, a data freshness for the data element may not be guaranteed in the way needed and, in the latter scenario, valuable resources of the computing infrastructure may be wasted.

A randomness value can be generated in some embodiments. For example, a history of measured access frequency values can be maintained and, upon determining that this history indicates that a randomness of the measured access frequency values is greater than a predefined randomness threshold value, a signal indicating that the data element is not suitable or eligible for sampling may be generated. This signal can indicate that the particular data element should be excluded from updating the data element in the target database according to a current refresh pattern.

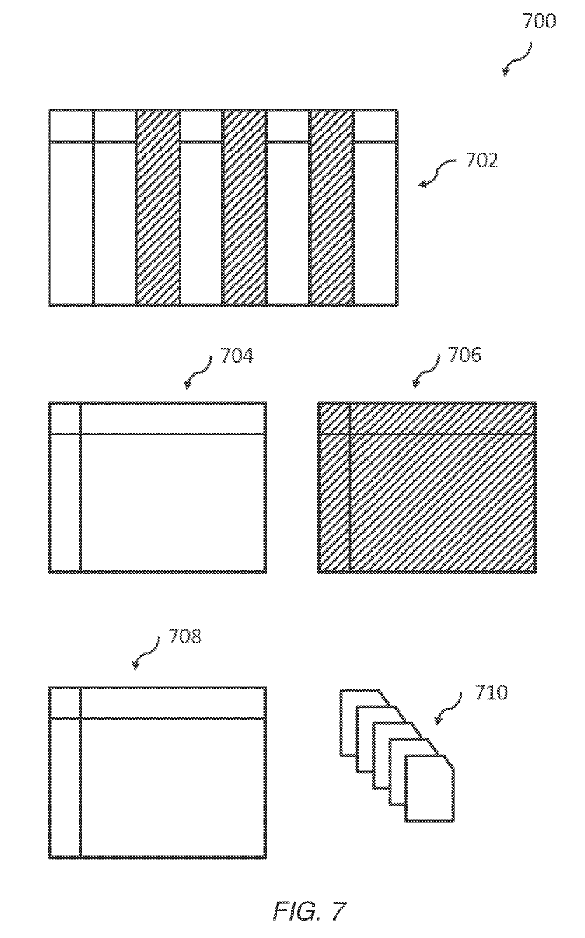

In additional embodiments, metadata may be maintained about data elements in the target database. The metadata may include metadata underlying any data element in the target database that is to be updated using a data source with an update frequency of at least twice the access frequency (or another predefined update frequency). In some embodiments, the data source may be a log reader for data replication from a source database. This type of data source may be typical for database management systems comprising auto-replication techniques for high-availability. The metadata for the data element may be implemented in different ways, e.g., as extra data within the target database (e.g., as extra columns or extra rows in a database table, as separate metadata tables, etc.) or outside the target database, e.g., as, or in, files maintained in a file system. This is discussed in greater detail below with respect to FIG. 7.

In the context of this description, the following technical conventions, terms and/or expressions may be used:

The term “sampling” of data in a database can refer to not using available information, e.g., based on statistical or mathematical models, on purpose in a target database system even though updated data is available in a data source system. Sampling may be performed in order to gain advantages such as less system load, better performance, reduced storage and/or computing resources, less data latency, minimum required data freshness, and so on. In some embodiments, sampling of data refers to using only selected update data for the target database even though source data for updating a data element would be available at a higher frequency.

The term “data source” can refer to any data storage or other origin of data to be used for updates of a target system, in particular, a target database or a target database system. In this sense, the data of the data source may come from a variety of objects, including applications, storage systems, networks, IoT devices, mobile devices, etc.

The term “target database” can refer to a database or database system used to store at least a part of the data from the data source. The target database may have different architectures including, but not limited to, relational databases (e.g., relational databases with a column- or row-orientation), object databases (e.g., for images or videos or audio streams), graph databases, document-oriented databases, databases for training data for machine learning systems, and so on.

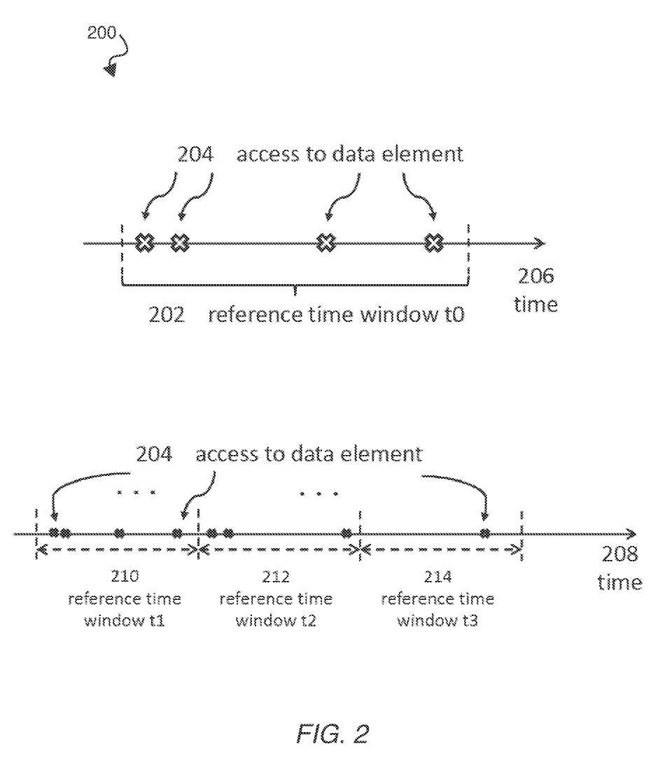

The term “access frequency” may also be interpreted as access bandwidth for a data element in the target database. The access frequency can be derived from the number times the data element in the target database is accessed (number of access events) in a reference time window of a predefined/constant or variable time length by a plurality of different data consumers. This is discussed in more detail below in the context of FIG. 2.

The term “data element” can refer to any data object stored in a database. In a simple case, the data element may be a data field in a record of a relational database. However, the definition of the data element may vary depending on the software application context. The data element may also refer to a complete data record, such as a partition or a table, etc. in the target database. In another example, the data element and its changes may be a stored image in the source database.

The term “reference time window” can refer to a time period used for determining the access frequency for a data element in question. The reference time window may be of constant length, and the beginning of a new reference time window may begin at the end of the previous reference time window. However, other implementations are possible. For example, a new reference time window may start the next time the data element is accessed (a next access event). In other embodiments, the length of the reference time window may be adopted depending on a (changing) access frequency determined for the data element.

The term “machine learning system” can refer to an artificial intelligence system. The machine learning system may produce output data depending on a set of input data after the machine learning system has been trained with training data, e.g., labeled training data in the case of supervised learning, to produce the output data. Hence, the machine learning system is not programmed in a procedural way, but “learns” behavior (the generation of output data to a given set of input data) during a training session. Labels can be the desired output to a related set of input data. During the training, nodes of the machine learning system can adapt their behavior to form a machine learning model. The set-up of the architecture of the machine learning system may be characterized by so-called hyperparameters. For example, in the case of a neural network, the number of nodes per layer, the number of layers in the machine learning system, connections between the different nodes, back propagation parameters, and functions can be defined. The term “prediction value” can refer to an output value of the machine learning system when a set of input values is presented to the input nodes of the machine learning system. One or more prediction values for the same set of input values may be predicted.

The term “metadata” can refer to data about data, e.g., data about a data element. The metadata can indicate specific features of data elements in the target database. These features may indicate whether or not a particular data element in the target database is a sampling candidate. Additional metadata features may describe whether a current sampling state is on or off, as well as the access frequency and the current refresh pattern of the data element. Further metadata features may include information indicating the quality of prediction values and information about the risk of a violation of a minimum required data freshness.

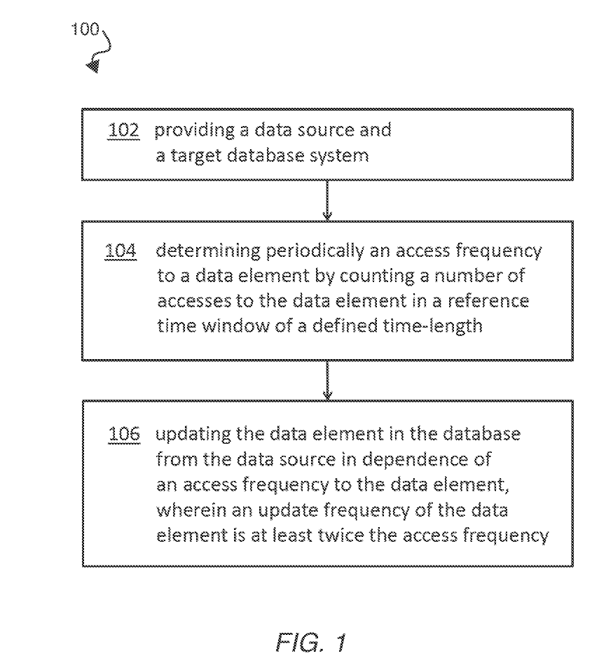

Turning now to the Figures, FIG. 1 is a flow diagram illustrating a process 100 of updating data in a database system, according to some embodiments. The method 100 can include providing, at operation 102, a data source (e.g., a source database or any other data source) and target database. In other embodiments, an already available data source and/or existing target database may be used. An existing data path between the data source and the target database can be provided as well.

At operation 104, an access frequency to a data element in the target database may be determined by determining a number of times the data element is accessed by one or more data consumers (a number of access events) in a reference time window of a defined length. The target database may be selected from a variety of different database types, e.g., relational databases which may be column- or row-oriented, object databases, graph databases, document databases, and so on. In some embodiments, the access frequency can be determined by dividing the number of access events determined for the data element by the length, e.g., in seconds, of the reference time window. The determination of the access frequency may be triggered regularly, e.g., at predefined regular time points, or according to another algorithm. In some embodiments, the reference time window may be varied/adjusted.

The data element in the target database can be updated depending on the determined access frequency to the data element. This is illustrated at operation 106. The refresh frequency for the data element can be at least twice the access frequency in some embodiments. It may also be higher if certain prerequisites are to be met. The refresh (e.g., update or replication) may be performed at a rate at least twice the access frequency, based on the Shannon-Nyquist theorem (see below). In some embodiments, the update at operation 106 can relate only to the specific data element, but the update may also influence other data elements.

Before turning to FIG. 2, it is worth considering the correlation between data access history and data refresh needs. Knowing the past, e.g., how many times a particular data element in a database has been accessed by data consumer(s), does not necessarily result in a precise prediction of the next data access. Some data consumer applications do not access data in a fixed temporal pattern, and access patterns may vary strongly due to irregularities and randomness in the processes. Further, irregular data access events may be user-driven.

If the access pattern for a data element is irregular, one can often expect multiple different data consumers accessing the same data element, making it difficult to exactly predict the next time the data will be accessed. If one considers the access events for a data element, as known from the past, as the bandwidth of a signal consisting of several access frequencies caused by several data consumers, a minimum sampling frequency can be derived from the Nyquist-Shannon theorem in order to avoid potential negative side effects of sampling caused by certain data not being updated frequently enough.

The Nyquist-Shannon sampling theorem can be used in digital signal processing to link the frequency range of the signal data and the sampling rate required to avoid a type of distortion called aliasing. The theorem states that the sampling rate must be at least twice the bandwidth of the signal to avoid aliasing. In other words, if one considers the access events of data consumers to a particular data element over time as a bandwidth of the signal, then, in order to reproduce the signal (e.g., to predict future access events), one would need to use at least twice the bandwidth to avoid “distortions” such as stale or outdated data that could cause negative effects for data consumers. Because “bandwidth” implies frequency (herein, access events within a given length of time), defining a reference time window can be a first step to monitor access to data elements.

FIG. 2 is a set of schematic diagrams showing examples 200 of access events in reference time windows, according to some embodiments. The first (top) diagram shows a single reference time window (t0) 202 on a time axis 206. Access events 204 in which any data consumer accesses a given data element are shown on the time axis 206. In this example, when the reference time window 202 reaches its end, four access events 204 have occurred. As discussed above, if the reference time window 202 has a length (“time length”) of 1 second, the access frequency can be f = 4/1 sec = 4 Hz. The minimum refresh frequency for a data element can be determined by f_{refresh} = 2 * (access count / time length) [1/sec]. In this example, when the access frequency is 4 Hz, the minimum refresh rate or frequency would be 8 Hz, or eight updates per second. Depending on a defined length of the reference time window, significant resources savings may be achieved since the update will not happen every time there is a change to the data element in the data source.

The second (bottom) diagram shows a concatenation of fixed length reference time windows 210, 212, 214 (respectively, t1, t2, and t3) on a time axis 208, as well as access events 204 for a data element. As can be seen from the access events 204 on time axis 208, a different number of access events is possible from reference time window to reference time window.

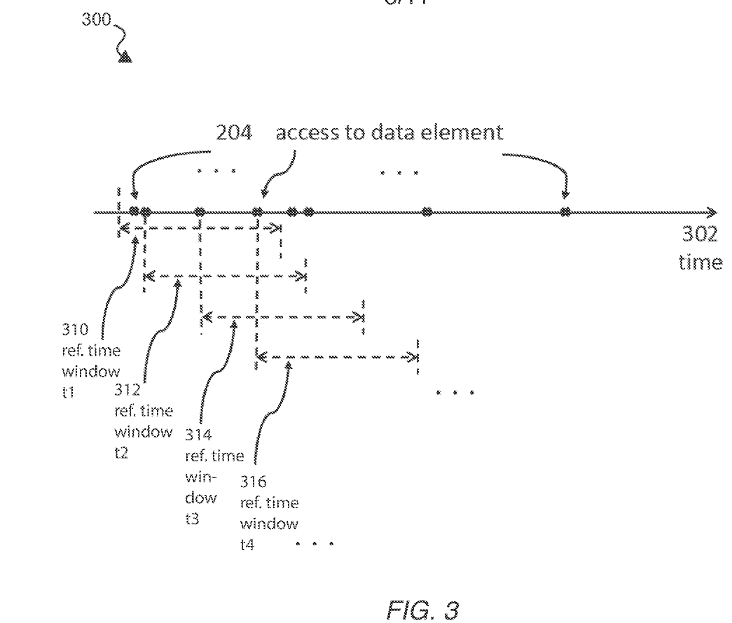

FIG. 3 is a schematic diagram showing another example 300 of access events 204 in reference time windows, according to some embodiments. In this example 300, new reference time windows 310, 312, 314, 316 (respectively, t1, t2, t3, t4) start with each new access event. This can lead to multiple reference time windows overlapping, as shown on time axis 302. While it may cost slightly more effort due to parallel measurements, this approach can offer a faster response to changes in the access frequency in some embodiments. For example, as soon as the first reference time window 310 has ended, a newly determined refresh pattern can be applied and maintained until the next reference time window 312, which has been started in parallel, is completed. If a change in access frequency compared to the previous access frequency is detected, the new refresh pattern can be immediately applied, and so on.

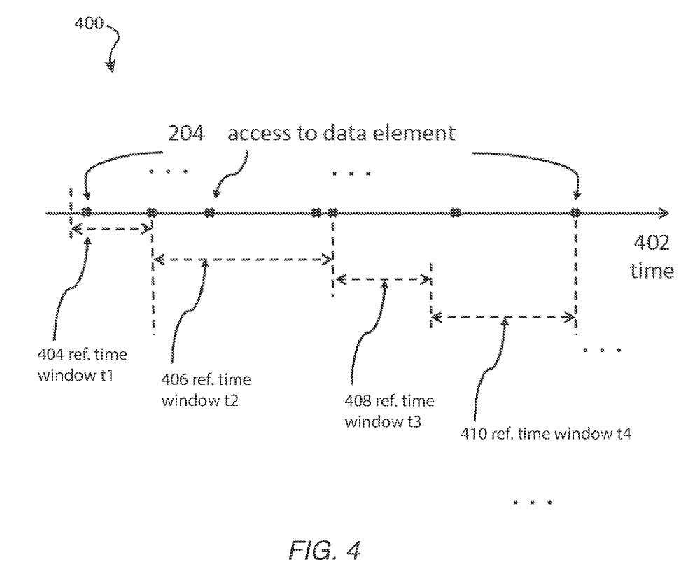

FIG. 4 is a schematic diagram showing another example 400 of access events 204 in reference time windows for a data element on a time axis 402, according to some embodiments. Adjusting the length of reference time windows based on changes in access frequency may enable a faster response to higher or lower update/refresh needs. In this example, access frequencies during several subsequent reference time windows 404, 406, 408, and 410 (respectively t1, t2, t3, and t4) can be compared and trends can be analyzed. In response to a trend toward increasing access frequency, the reference time window may be shortened, allowing for faster reaction to a high-end need on update actions. Similarly, a trend towards a decreasing access frequency could extend the reference time window. This can allow maintenance of a minimum number of updates that will avoid data staleness.

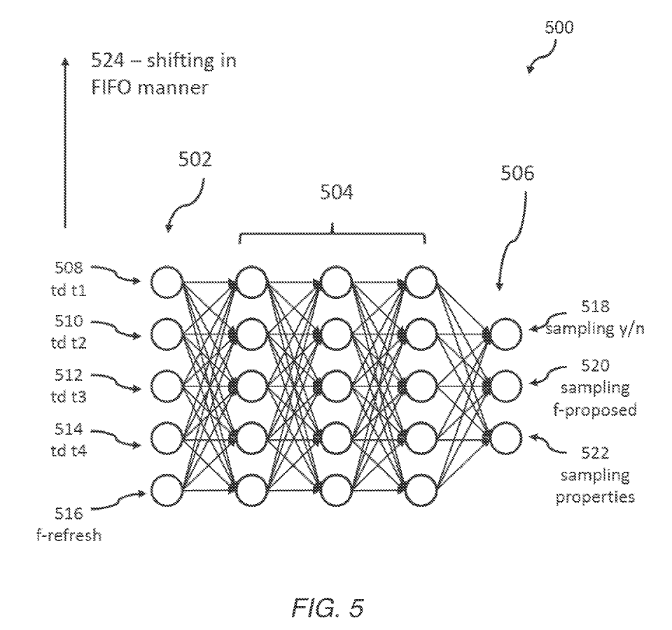

FIG. 5 is a schematic diagram illustrating a neural network 500 for updating data in a database system, according to some embodiments. The disclosed update processes may be carried out using a traditional/procedural approach in some embodiments. However, a trained machine learning system, e.g., the neural network 500 shown in FIG. 5, may be used in further embodiments. The illustrated example neural network 500 includes input layer nodes 502, three hidden layers 504 each having five nodes, and an output layer 506 having three nodes. The neural network 500 is shown as a fully connected network of nodes, each including a respective predefined transmission function. However, neural networks with other numbers of input and output nodes, as well as different numbers of hidden layers and respective nodes, are possible. This is also true for other types of machine learning system architectures that may be used in some embodiments.

As shown in FIG. 5, one of the input layer nodes 502 can be used to receive a current update or refresh frequency (f-refresh) 516. The other available input layer nodes 502 (4 input layer nodes in this example) are used to receive time delta (td) values as time differences between access events for a given data element, corresponding to signals 508, 510, 512, and 514. In the illustrated example, signal 508 provided to the topmost input layer node 502 is a td value for the time difference between a first access event (at time t1) and a second access event (at time t2) for the data element, signal 510 corresponds to the time difference between the second access event and a third access event (at time t3) for the data element, and so on.

In some embodiments, the number of available td values may exceed the number of available input layer nodes 502. In these instances, the available input layer nodes 502 may be provided for the respective td values in a FIFO (“first-in-first-out”) manner 524. For example, the last available time delta value (td t4), corresponding to signal 514, can be fed to one of the available input layer nodes 502 while the already existing td values from previous access times (td t3, td t2, and td t1) are shifted (in this example, upward) to a next input layer node according to a predefined sequence of the input layer nodes 502. In this way, the earliest measured td value would no longer be provided to one of the input layer nodes 502.

The neural network 500 may generate a set of prediction values for each data element including (i) a sampling “yes/no” signal 518, (ii) an update frequency 520, and (iii) additional sampling properties 522. The sampling properties 522 may include more than one prediction value, in which case more output nodes may be required in the output layer 506. Before the neural network 500 can be deployed in this context for the purpose described, appropriate training with labeled training data may be required. Labeling can be used to relate output values to related input values. The training data can include badges of time delta values between data access events plus a current, related update frequency. Advantageously, the different examples described above for choosing a reference time window length could be used for training and test data generation. The trained neural network may work faster in the described environment and deal more effectively with unforeseen situations and data access patterns.

An update frequency calculated based on previous data access events can be a prediction into the future behavior of the data consumers. If a current update frequency, which was predicted, matches “well” with an access frequency measured after the next reference time window, this can indicate that the prediction was good and the risk of providing stale data is low. However, if the next measured access frequency deviates significantly from the current update frequency, this can indicate that the prediction was bad and the risk of providing stale data is high. This quality evaluation may be dependent on the needs of data consumers and may be controlled by pre-determined threshold values or value ranges. For some critical data consumers, the quality of prediction may be set higher than standard, which would lead to an exclusion of the affected data element from sampling, at least temporarily. These threshold values (e.g., indicating a threshold difference between a predicted update frequency and a next measured access frequency) may be included in a set of metadata.

In addition, specific metadata about sampled data elements may be maintained to control a target database that uses sampling. For example, the set of metadata may include metadata indicating (i) whether a particular data element can be a sampling candidate or not, (iii) whether a current sampling state is on or off, (iv) an access frequency for the data element, and (v) a current refresh pattern. In addition, information about the quality of the output predictions and/or information about the risk of breaching a minimum required data freshness can be included in the set of metadata.

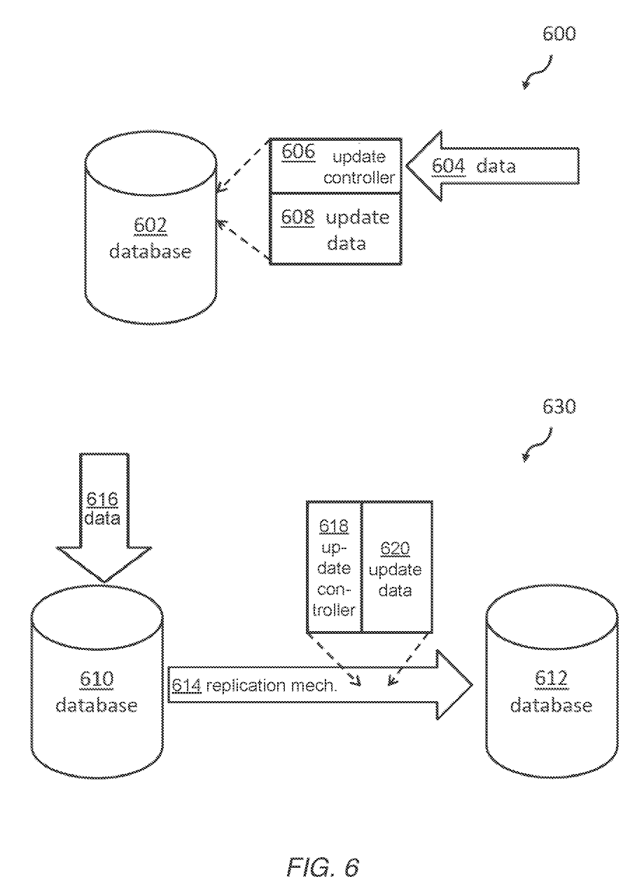

Before further discussion of managing the set of metadata, example architecture approaches for data sources and a target database shall be described with reference to FIG. 6, which is a set of schematic diagrams illustrating examples 600 and 630 of architecture approaches for data sources and target databases, according to some embodiments.

In the first example 600, data elements to be updated (data 604) can be received from an update controller 606 managing updating of data (“update data”) 608 in the target database 602. In this example 600, the source of the data 604 could be any data source (not shown). For example, the data source may be a plurality of environmental sensors in an IoT (Internet-of-Things) environment. However, the data 604 may be sourced from any potential data source including other databases, other applications, other interfaces, and so on.

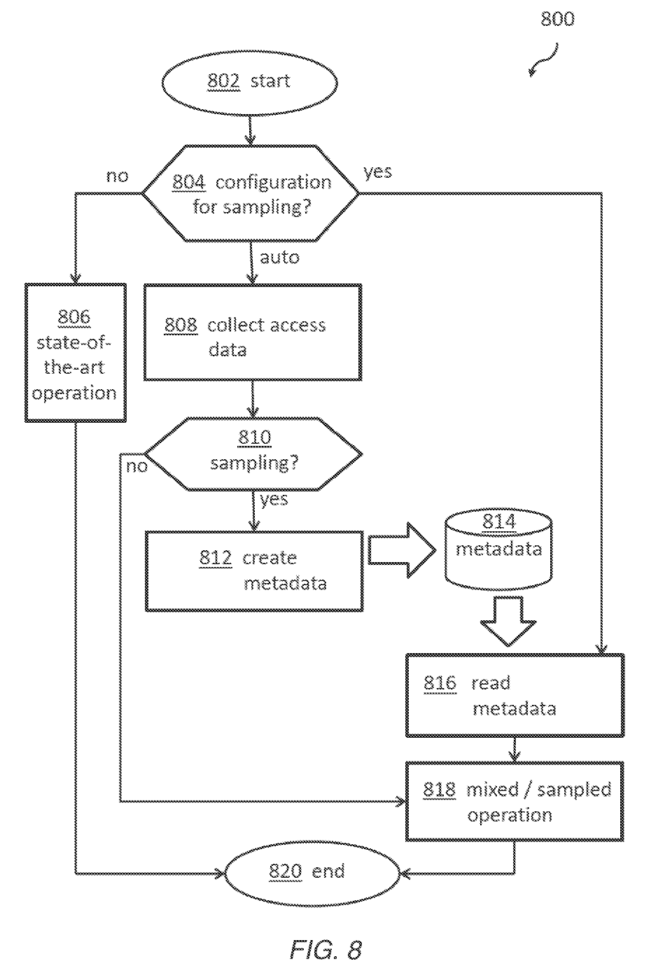

In the second example 630, data 616 may be received from a source database 610 for updating specific data elements in the source database 610. This source database 610 can be connected to a replication mechanism 614 that replicates data from the source database 610 to the target database 612. In this case, an update controller 618 can manage the replication mechanism 614, e.g., as described with respect to FIG. 8, so that a single field data replication to the target database 612 is not triggered for every available update data 620 corresponding to data elements in the source database 610. This may reduce the computational cost of the data replication. In some embodiments, the replication mechanism 614 may read the data to be replicated from a data log (not shown) maintained by the source database 610 or a related database management system. These data in the data log may be extracted by a log reader (not shown) and used as source data in some embodiments.

FIG. 7 is a schematic diagram illustrating examples 700 of managing metadata for data elements, according to some embodiments. In the first example, a table 702 of a relational database may be extended with metadata storing control data required for updating data in a database system. Therefore, in table 702, metadata is in columns inside the database tables (shown with diagonal line filling in table 702). In the second example, there can be a regular database table 704 and an additional database table 706 that only stores the metadata. In the third example, there can be a regular database table 708 for which metadata 710 can be stored in a file system, which may be a central file system to support one or more databases with the required metadata 710.

FIG. 8 is a flow diagram illustrating a process 800 of selecting an update mode for data elements in a target database, according to some embodiments. The process can start at 802. At operation 804, it can be determined whether the target database and/or a replication process is configured for sampling. If the target database is not configured for sampling (804: no), the replication process can be performed without sampling (using any state-of-the-art operation for updating) at operation 806. If the sampling configuration is determined to be “auto” at operation 804, access data for a selected data element can be collected at operation 808. It can be determined based on the access data whether the selected data element is enabled for sampling at operation 810. If the selected data element is not configured for sampling (810: no), process 800 can proceed in a mixed operation mode that includes sampling enabled data elements and not sampling non-enabled data elements at operation 818 before ending at operation 820.

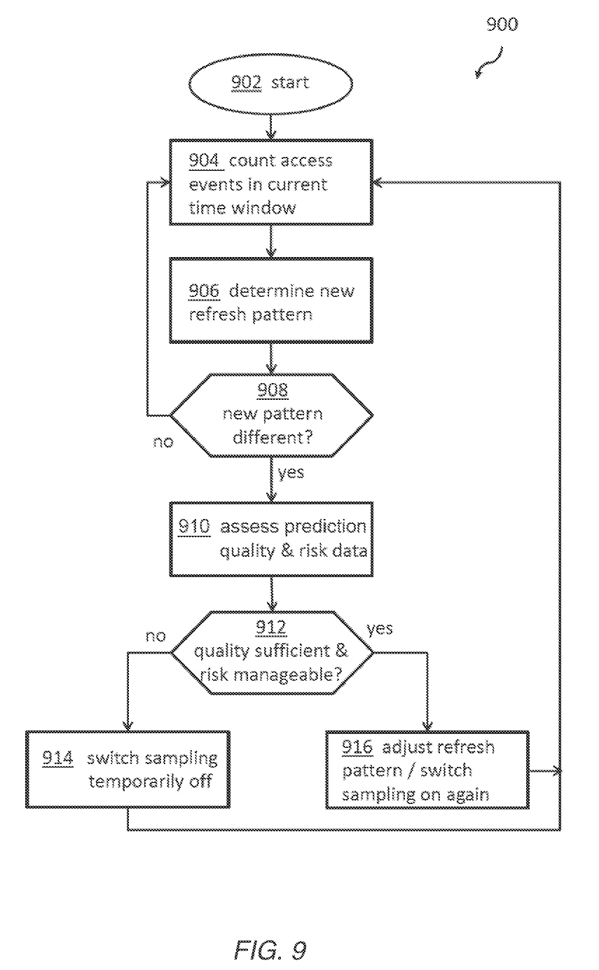

However, if it is determined that the data element is enabled for sampling (810: yes), metadata supporting the process can be created at operation 812, e.g., in the form of metadata as described in the context of FIG. 7, and stored in a metadata storage 814. In parallel, the metadata can be read at operation 816, and process 800 can continue to operation 818 with the steps provided for sampled (or mixed, i.e., sampled and classical/not sampled) operations. This is shown in FIG. 9.

FIG. 9 is a flow diagram illustrating a process 900 of monitoring access to data elements for evaluating/updating refresh patterns of the data elements in a target database, according to some embodiments. As discussed above, the refresh patterns may be updated based on determining a minimum update/refresh/replicate frequency for maintaining a given data freshness. The process can start operation 902. At operation 904, access events for a data element in a current time reference window can be counted. The current time window may be applying a refresh pattern (update frequency) determined based on a previously predicted minimum update frequency or otherwise determined update/refresh/replicate frequency. A new refresh pattern can be determined for the data element at operation 906. Determining refresh patterns is discussed in greater detail above.

If the new refresh pattern is not different than the previous refresh pattern (908: no), the process can loop back to operation 904 and continue counting access events for the data element. However, if the new refresh pattern is different than the previous refresh pattern (908: yes), predicted quality values and related risk factors of the new refresh pattern can be assessed at operation 910. As discussed in greater detail above, the new refresh pattern can be a prediction or forecasting result based on classical forecasting techniques (e.g., statistical methods) or machine learning techniques, which can also output the quality values and related risk factors.

If, based on the assessment at operation 910, the quality is sufficient and the risk is manageable (912: yes), process 900 may continue with an adjusted refresh pattern. This is illustrated at operation 916. The refresh pattern can be adjusted by switching to sampling “on” for the data element in instances where sampling had previously been turned “off” for this data element due to insufficient quality or non-manageable risk. However, if the quality is insufficient and/or the risk is not manageable (912: no), sampling can be temporarily switched to “off” for the data element. This is illustrated at operation 914. After operation 914 or 916, process 900 can then loop back to counting access events at operation 904.

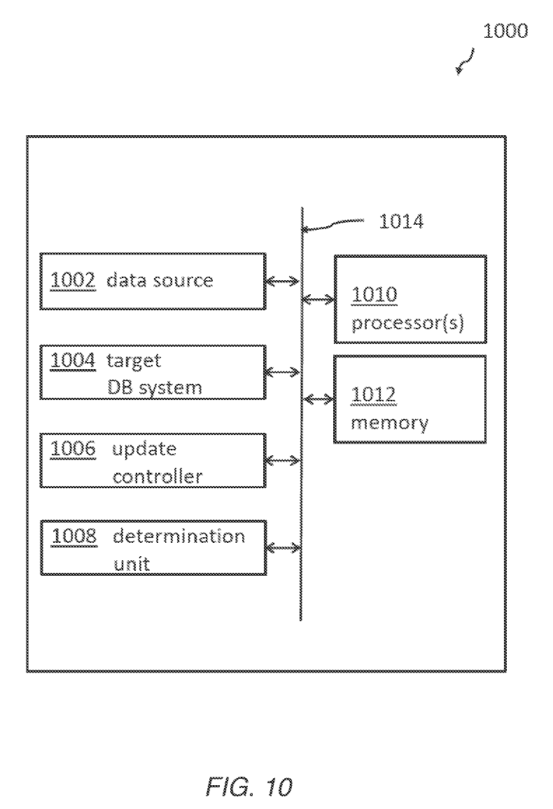

FIG. 10 is a block diagram illustrating a database management system 1000 for updating data in a target database, according to some embodiments. The system can include a processor 1010 and a memory 1012 communicatively coupled to the processor 1010. The memory 1012 can store program code portions that, when executed, enable the processor 1010 to perform the above-described operations (e.g., process 100). The database management system 1000 can include a data source 1002 and a target database (DB) system 1004. The database management system 1000 can also include an update controller 1006, which may include an update sub-controller. In some embodiments, the processor 1010 is enabled to periodically determine, using a determination unit 1008, an access frequency for a data element in the target DB system 1004 by counting a number of access events for the data element in a reference time window of a defined time length. The processor 1010 can also be enabled to update, using the update sub-controller, the data element in the target DB system 1004 from the data source 1002 depending on the access frequency determined for the data element, wherein an update frequency for the data element in the target DB system 1004 is at least twice the access frequency. In some embodiments, the determination unit 1008 and the update sub-controller can both be integrated into the update controller 1006. Optionally, the processor 1010 can be enabled to establish, using the update controller 1006, at least one data path from the data source 1002 to a target database or target database system 1004.

In some embodiments, all functional units, modules, and functional blocks in the database management system 1000, including the data source 1002, the target DB system 1004, the update controller 1006, the processor 1010, the memory 1012, the update controller 1006, and the determination unit 1008, may be communicatively coupled to each other for signal and/or message exchange in a selected 1:1 manner. Alternatively, the functional units, modules and functional blocks can be linked to a system internal bus system 1014 for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

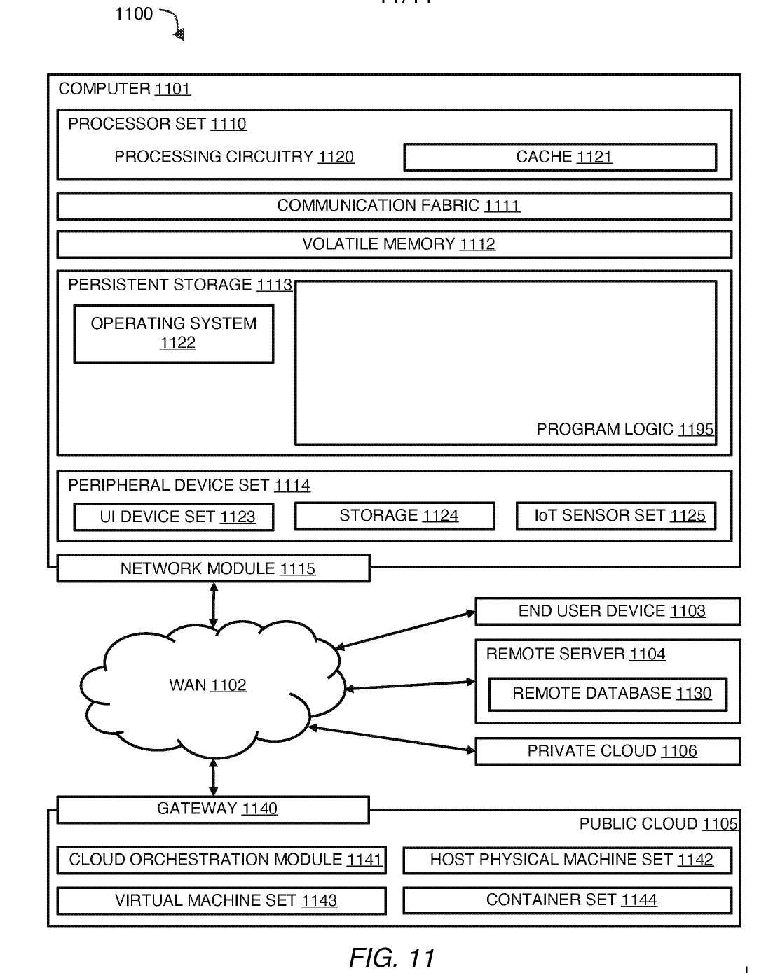

FIG. 11 is a block diagram illustrating a computing environment 1100, according to some embodiments. Computing environment 1100 contains an example of an environment for the execution of at least some of the computer code involved in performing the inventive methods, such as updating data in a target database 1195. In some embodiments, not shown in FIG. 11, the database management system 1000 illustrated in FIG. 10 can be an operational sub-system of the computer 1101 and may be attached to a computer-internal bus system. In addition, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1195, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer-readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1195 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in block 1195 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer-readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

CLOUD COMPUTING SERVICES AND/OR MICROSERVICES (not separately shown in FIG. 11): private and public clouds 1106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the present disclosure.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. However, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, and item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; ten of item C; four of item B and seven of item C; or other suitable combinations.

Although the present invention has been described in reference to specific embodiments, it should be understood that the invention is not limited to these examples only and that many variations of these embodiments may be readily envisioned by the skilled person after having read the present disclosure. The invention may be described without limitation, and by way of example only, by the following embodiments.

Embodiment 1: A computer-implemented method for updating data in a target database, the method comprising:

determining an access frequency to a data element in the target database by counting a number of accesses to the data element in a reference time window of a defined time-length, and

updating the data element in the target database from a data source depending on the access frequency to the data element, wherein an update frequency for the data element in the target database is at least twice the access frequency.

Embodiment 2: The method according to embodiment 1, wherein a new reference time window starts at the end of a previous reference time window.

Embodiment 3: The method according to embodiment 1, wherein a new reference time window starts with each new access to the data element.

Embodiment 4: The method according to any of embodiments 1–3, further comprising:

adjusting the defined time-length of the reference time window dynamically depending on the number of accesses in a current reference time window.

Embodiment 5: The method according to embodiment 4, further comprising adjusting the defined time-length of the reference time window using a trained machine learning system comprising a trained machine learning model, wherein:

a plurality of time delta values between the data accesses to the data element in the target database and a current update frequency value is used as input for the machine learning system; and

prediction values of the machine learning system comprise at least one out of the group comprising a sampling recommendation, an update frequency, and a further sampling property.

Embodiment 6: The method according to embodiment 5, further comprising:

upon determining that an absolute value of a difference between the predicted update frequency value and an actually measured access frequency value to the same data element is larger than a first predefined difference value, decreasing the update frequency value for the data element; and

upon determining that the absolute value of the difference between the predicted update frequency value and the actually measured access frequency value to the same data element is larger than a second predefined difference value, increasing the update frequency value for the data element.

Embodiment 7: The method according to embodiment 5 or 6, further comprising:

updating the data element in the target database if a required data quality value is below a predefined quality value.

Embodiment 8: The method according to embodiment 7, wherein the data quality value is expressed as a ratio between a previously predicted update frequency and an actually measured access frequency to the same data element.

Embodiment 9: The method according to any of embodiments 1–8, further comprising:

maintaining metadata about data elements in the target database, the metadata underlying a data element in the database to be updated from the data source with at least twice the access frequency.

Embodiment 10: The method according to any of embodiments 1–9, wherein the data source is a log reader for data replication from a source database.

Embodiment 11: The method according to any of embodiments 4–10, further comprising:

maintaining a history of measured access frequency values; and

upon determining that the history of measured access frequency values indicates that a randomness of the measured access frequency values is greater than a predefined randomness threshold value, generating a signal indicating that the data element is not intended for sampling.

Embodiment 12: A database management system for updating data in a target database, the database management system comprising:

a processor and a memory, communicatively coupled to the processor, wherein the memory stores program code portions that when executed, enable the processor, to:

determine periodically an access frequency to a data element in the target database by counting a number of accesses to the data element in a reference time window of a defined time-length; and

update the data element in the target database from a data source depending on the access frequency to the data element, wherein an update frequency for the data element in the target database is at least twice the access frequency.

Embodiment 13: The database management system according to embodiment 12, wherein a new reference time window starts at the end of a previous reference time window.

Embodiment 14: The database management system according to embodiment 12, wherein a new reference time window starts with each new access to the data element.

Embodiment 15: The database management system according to any of embodiments 12–14, wherein the processor is further enabled to adjust the defined time-length of the reference time window dynamically depending on the number of accesses in a current reference time window.

Embodiment 16: The database management system according to embodiment 15, wherein the processor is further enabled to adjust the defined time-length of the reference time window using a trained machine learning system comprising a trained machine learning model, and wherein:

a plurality of time delta values between the data accesses to the data element in the target database and a current update frequency value is used as input for the machine learning system; and

prediction values of the machine learning system comprise at least one out of the group comprising a sampling recommendation, an update frequency, and a further sampling property.

Embodiment 17: The database management system according to embodiment 15 or 16, wherein the processor is further enabled to update the data element in the target database if a required data quality value is below a predefined quality value.

Embodiment 18: The database management system according to any of embodiments 12–17, wherein the processor is further enabled to maintain metadata about data elements in the target database, wherein the metadata underlying a data element in the database to be updated from the data source with at least twice the access frequency.

Embodiment 19: The database management system according to any of embodiments 12–18, wherein the data source is a log reader for data replication from a source database.

Embodiment 20: A computer program product for updating data in a target database, the computer program product comprising a computer readable storage medium having program instructions embodied therewith, the program instructions being executable by one or more computing systems or controllers to cause the one or more computing systems to:

determine periodically an access frequency to a data element in the target database by counting a number of accesses to the data element in a reference time window of a defined time-length; and

update the data element in the target database from a data source depending on the access frequency to the data element, wherein an update frequency for the data element in the target database is at least twice the access frequency.

What is claimed is:

1. A method, comprising:
determining an access frequency for a data element in a target database based on a number of access events for the data element in a reference time window of a defined time-length; and
updating the data element from a data source according to a refresh pattern determined based on the access frequency, wherein the updating comprises updating the data element with an update frequency at least twice the access frequency.

2. The method of claim 1, wherein a new reference time window starts at an end of the reference time window.

3. The method of claim 1, wherein a new reference time window starts each time the data element is accessed.

4. The method of claim 1, further comprising:
monitoring, for the data element, access events in new reference time windows; and
dynamically adjusting the defined time-length for at least one of the new reference windows.

5. The method of claim 4, further comprising:
determining, for each of the new reference time windows, a current update frequency and time delta values between the monitored access events, wherein:
the dynamically adjusting is based on values generated by a trained machine learning system comprising a trained machine learning model that uses the current update frequency and the time delta values and as inputs; and
the trained machine learning system is configured to generate, for the data element in a first reference time window of the new reference time windows, at least one output selected from the group consisting of a sampling recommendation, a predicted update frequency, and a further sampling property.

6. The method of claim 5, further comprising:
measuring an access frequency for the data element in a second reference time window of the new reference time windows; and
based on an absolute value of a difference between the predicted update frequency and the measured access frequency, increasing or decreasing an update frequency of the data element.

7. The method of claim 6, further comprising updating the data element in response to determining that a data quality value is below a predefined data quality value.

8. The method of claim 7, wherein the data quality value is expressed as a ratio between the predicted update frequency and the measured access frequency.

9. The method of claim 4, further comprising:
maintaining a history of measured access frequency values for the data element based on the monitored access events; and
in response to determining, based on the history, that a randomness of the measured access frequency values is greater than a predefined randomness threshold value, generating a signal indicating that the data element is not intended for sampling.

10. The method of claim 1, further comprising:
maintaining metadata about data elements in the target database, the metadata indicating whether the data elements are enabled for sampling.

11. The method of claim 1, wherein the data source is a log reader for data replication from a source database.

12. A system, comprising:
a processor set;
one or more computer-readable storage media; and
program instructions stored on the one or more computer-readable storage media to cause the processor set to perform operations comprising:
determining an access frequency for a data element in a target database based on a number of access events for the data element in a reference time window of a defined time-length; and
updating the data element from a data source according to a refresh pattern determined based on the access frequency, wherein the updating comprises updating the data element with an update frequency at least twice the access frequency.

13. The system of claim 12, wherein a new reference time window starts at an end of the reference time window.

14. The system of claim 12, wherein a new reference time window starts each time the data element is accessed.

15. The system of claim 12, wherein the operations further comprise:
monitoring, for the data element, access events in new reference time windows; and
dynamically adjusting the defined time-length for at least one of the new reference windows.

16. The system of claim 15, wherein:
determining, for each of the new reference time windows, a current update frequency and time delta values between the monitored access events, wherein:
the dynamically adjusting is based on values generated by a trained machine learning system comprising a trained machine learning model that uses the current update frequency and the time delta values and as inputs; and
the trained machine learning system is configured to generate, for the data element in a first reference time window of the new reference time windows, at least one output selected from the group consisting of a sampling recommendation, a predicted update frequency, and a further sampling property.

17. The system of claim 15, wherein the operations further comprise updating the data element in response to determining that a data quality value is below a predefined data quality value.

18. The system of claim 12, wherein the operations further comprise:
maintaining a history of measured access frequency values for the data element; and
in response to determining, based on the history, that a randomness of the measured access frequency values is greater than a predefined randomness threshold value, generating a signal indicating that the data element is not intended for sampling.

19. The system of claim 12, wherein the data source is a log reader for data replication from a source database.

20. A computer program product comprising:
one or more computer-readable storage media; and
program instructions stored on the one or more computer-readable storage media to perform operations comprising:
determining an access frequency for a data element in a target database based on a number of access events for the data element in a reference time window of a defined time-length; and
updating the data element from a data source according to a refresh pattern determined based on the access frequency, wherein the updating comprises updating the data element with an update frequency at least twice the access frequency.
